(19) United States
(12) Patent Application Publication
(10) Pub. No.: US 2025/0165208 A1
(43) Pub. Date: May 22, 2025

(54) CONTENT SHARING METHOD AND ELECTRONIC APPARATUS THEREOF

(71) Applicant: SAMSUNG ELECTRONICS CO., LTD., Suwon-si (KR)

(72) Inventors: Juanjuan HUANG, Guangzhou (CN); Liheng ZHANG, Guangzhou (CN); Qin ZHOU, Guangzhou (CN); Wenjie KE, Guangzhou (CN)

(73) Assignee: SAMSUNG ELECTRONICS CO., LTD., Suwon-si (KR)

(21) Appl. No.: 19/008,119

(22) Filed: Jan. 2, 2025

Related U.S. Application Data
(63) Continuation of application No. PCT/KR2023/004478, filed on Apr. 3, 2023.

(30) Foreign Application Priority Data
Aug. 12, 2022 (CN) 202210967222.5

(51) Int. Cl. G06F 3/14; G06F 3/04817; G06F 3/04842; G06F 3/16

(52) U.S. Cl. CPC G06F 3/1454; G06F 3/04817; G06F 3/04842; G06F 3/167

(57) ABSTRACT

A content sharing method for a first electronic apparatus includes creating a virtual screen for displaying to a vehicle machine, projecting the virtual screen to a screen of the vehicle machine, based on receiving a sharing command from the vehicle machine, establishing a predetermined wireless communication connection with a second electronic apparatus, and sending, to the second electronic apparatus through the predetermined wireless communication connection, sharing data corresponding to the sharing command.

### CROSS-REFERENCE TO RELATED APPLICATIONS

This application is a continuation application of International Application No. PCT/KR2023/004478, filed on Apr. 3, 2023, which claims priority to Chinese Patent Application No. 202210967222.5, filed on Aug. 12, 2022, in the China National Intellectual Property Administration, the disclosures of which are incorporated by reference herein in their entireties.

### BACKGROUND

### 1. Field

The present disclosure relates generally to electronic devices, and more particularly, to a content sharing method and device and an electronic apparatus thereof.

### 2. Description of Related Art

Recent developments in technology have caused an increase in popularity of electronic apparatus, such as, but not limited to, smartphones, cellular phones, tablet computers, digital cameras, personal digital assistants (PDAs), wearable devices, or the like, and/or vehicles, such as, but not limited to, automobiles, trucks, buses, self-driving vehicles, or the like. As such, vehicles have been equipped with a vehicle machine, which may play audio, video, or the like on an electronic apparatus connected to the vehicle machine. The vehicle machine may also support displaying an application page (such as, but not limited to, a shopping page, a news page, or the like) on a screen of the vehicle machine, and passengers may operate the played audio and/or video and the displayed page on the screen of the vehicle machine. A combination and/or collaboration of the electronic apparatus, a vehicular audio system, and the screen of the vehicle machine may provide more audio-visual entertainment options, better immersive music experience effects, and/or more convenient operability to occupants in the vehicle, when compared to a situation in which the electronic apparatus, the vehicular audio system, and the screen of the vehicle machine may operate independently of each other. Consequently, when the passengers in the vehicle respond to and like contents that they experience in the vehicle, sharing needs between the electronic apparatus in the vehicle may increase.

### SUMMARY

According to an aspect of the present disclosure, a content sharing method for a first electronic apparatus includes creating a virtual screen for displaying to a vehicle machine, projecting the virtual screen to a screen of the vehicle machine, based on receiving a sharing command from the vehicle machine, establishing a predetermined wireless communication connection with a second electronic apparatus, and sending, to the second electronic apparatus through the predetermined wireless communication connection, sharing data corresponding to the sharing command.

According to an aspect of the present disclosure, a content sharing device for a first electronic apparatus includes at least one processor, and a memory storing instructions. The instructions are configured to, when individually or collectively executed by the at least one processor, cause the content sharing device to create a virtual screen for displaying to a vehicle machine, project the virtual screen to a screen of the vehicle machine, based on receiving a sharing command from the vehicle machine, establish a predetermined wireless communication connection with a second electronic apparatus, and send, to the second electronic apparatus through the predetermined wireless communication connection, sharing data corresponding to the sharing command.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description, taken in conjunction with the accompanying drawings, in which:

FIG. 1 is a flowchart illustrating a content sharing method for a first electronic apparatus, according to an embodiment of the present disclosure;

FIG. 2 is a diagram illustrating an example of displaying a sharing widget on a predetermined content on a screen of a vehicle machine, according to an embodiment of the present disclosure;

FIG. 3A is a diagram illustrating an example of displaying an enabling widget on a screen of a vehicle machine, according to an embodiment of the present disclosure;

FIG. 3B is a diagram illustrating an example of displaying a prompt icon on a screen of a vehicle machine, according to an embodiment of the present disclosure;

FIG. 4 is a diagram illustrating an interactive example of a content sharing method for a first electronic apparatus, according to an embodiment of the present disclosure;

FIG. 5 is a block diagram illustrating a content sharing device for a first electronic apparatus, according to an embodiment of the present disclosure;

FIG. 6 is a block diagram illustrating an electronic apparatus, according to an embodiment of the present disclosure; and

FIG. 7 is a block diagram illustrating an electronic apparatus, according to an embodiment of the present disclosure.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

The terms “upper,” “middle”, “lower”, and the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

A content sharing method in a related vehicle environment is described below.

In the vehicle environment, a driver may connect their electronic apparatus to a vehicle machine, and may play an audio file (hereinafter referred to as music) on the electronic apparatus by operating on an interface of the vehicle machine. As used herein, the electronic apparatus may be and/or may include, for example, a smartphone, a cellular phone, a tablet computer, a digital camera, a personal digital assistants (PDA), a wearable device, or the like. However, the present disclosure is not limited thereto. A passenger may like the music played through the vehicle machine very much, and at the same time, may be interested in news content displayed on a screen of the vehicle machine, and thus may expect to be able to obtain the music and the news content. To this end, the passenger may obtain the music and news content in one or more of the following manners.

In a first manner, the driver may first view information on the music and the news content on their electronic apparatus, and may verbally convey the information to the passenger, so that the passenger may use their electronic apparatus to search for the music and the news content themselves. In a second manner, the passenger may view the information on the music and the news content directly on the driver's electronic apparatus, and may use their own electronic apparatus to search for the music and the news content. In a third manner, the passenger and the driver may add each other as friends on their respective electronic apparatus, and the driver may operate their own electronic apparatus to share the music and the news content with the electronic apparatus of the passenger. In a fourth manner, the passenger may identify the music by listening to the music and may search for the music using their own electronic apparatus. In a fifth manner, the passenger may verbally inquire about the news content from the driver.

However, the content sharing methods described above may be lacking in certain respects.

For example, if the driver checks the information on the music and the news content on their electronic apparatus, the checking may cause an attention of the driver to be distracted, which may be a serious safety risk. As another example, there is a risk of a privacy leakage if the passenger views the information on the music and the news content on the driver's electronic apparatus. As another example, if the passenger and the driver attempt to add each other as friends, the corresponding application may be disabled during driving, and, as such, the attempt may not be successful. On the other hand, when the driver and the passenger are unfamiliar with each other, the adding of the friend relationship between the driver and the passenger may also bring a risk of privacy leakage. As another example, if the passenger identifies and searches for the music by themselves, the search may not be successful if, for example, many music versions are searched and an appropriate music version cannot be accurately selected. As another example, if the passenger verbally inquires the driver about the news content, the driver may be distracted, and/or the driver may not clearly determine what the passenger expects and may not be able to provide assistance. Furthermore, if a plurality of passengers desire to share the content, or the passenger desires to share multiple content, the above described content sharing methods may need to be repeatedly executed, which may increase the negative impact of these approaches.

Embodiments of the present disclosure provide a content sharing method and a content sharing device for a first electronic apparatus, a computer readable storage medium, and an electronic apparatus, which may realize a convenient and accurate content sharing between the electronic apparatus of a driver and a passenger while ensuring a driving safety.

Embodiments of the present disclosure provide a content sharing method and a content sharing device for a first electronic apparatus, a computer readable storage medium, and an electronic apparatus, in which a projected content sharing function of a vehicle machine is added to the electronic apparatus. When the projected content sharing function of the vehicle machine on the driver's electronic apparatus is allowed, a sharing widget may be displayed on a shareable interface on a screen of the vehicle machine, and when the sharing widget is activated, the content sharing between the driver's electronic apparatus and the passenger's electronic apparatus may be implemented by a predetermined wireless communication manner, such as, but not limited to, a short range wireless communication manner.

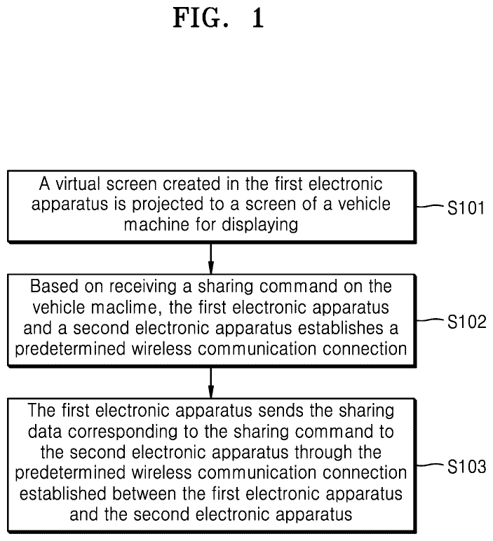

FIG. 1 is a flowchart illustrating a content sharing method for a first electronic apparatus, according to an embodiment of the present disclosure. The first electronic apparatus may be and/or may include an electronic apparatus of a driver. However, the present disclosure is not limited thereto. For example, the first electronic apparatus may be and/or may include an electronic apparatus of a passenger. Additionally or alternatively, as described above, the first electronic apparatus may include, for example, a smartphone, a cellular phone, a tablet computer, a digital camera, a PDA, a wearable device, or the like. However, the present disclosure is not limited thereto.

Referring to FIG. 1, in operation S101, a virtual screen created in the first electronic apparatus may be projected to a screen of a vehicle machine for displaying.

In an embodiment, where the first electronic apparatus is connected to the vehicle machine in a wired communication connection (e.g., universal serial bus (USB), or the like) or a wireless communication connection (e.g., Bluetooth™, wireless car box, or the like), so as to establish a communication channel between the electronic apparatus and the vehicle machine, the vehicle machine may send a screen size of the vehicle machine to the first electronic apparatus. When a projection displaying is desired, the first electronic apparatus may create a screen suitable for being displayed on the screen of the vehicle machine as the virtual screen according to the screen size of the vehicle machine, and project the created virtual screen to the screen of the vehicle machine for displaying. In this manner, a user (e.g., the driver or the passenger of the vehicle) may operate the first electronic apparatus on the screen of the vehicle machine, for example, play an audio files (e.g., music) in the first electronic apparatus, view a page (e.g., a news page) of an application in the first electronic apparatus. That is, the first electronic apparatus may exhibit the application desired by the user on the virtual screen, and encode data of the virtual screen. In an embodiment, the first electronic apparatus may transmit the encoded data to the vehicle machine through the communication channel. The vehicle machine may receive the encoded data, decode the encoded data, and display the decoded data of the virtual screen on the screen of the vehicle machine. A screen of the first electronic apparatus may display content of a main screen (e.g., a desktop), and the screen of the vehicle machine may display content of the virtual screen (e.g., a Baidu Carlife+ screen, an Apple CarPlay screen, or the like), which may be used to display a navigation, play music, display news, or the like). In an embodiment, the content displayed on the screen of the vehicle machine may not be affected by the screen of the first electronic apparatus at this stage. However, a sharing widget (e.g., a sharing button) for determining the content sharing, an enabling widget for enabling a wireless communication function of the first electronic apparatus, a prompt icon for prompting to enable a wireless communication function of other electronic apparatus, or the like may be created through the virtual screen, and projected and displayed on the screen of the vehicle machine.

For example, after the first electronic apparatus is connected to the vehicle machine, the user may choose to play the music on the screen of the vehicle machine through the virtual screen. The first electronic apparatus may record audio data of the music, encode the recorded audio data, and send the encoded audio data to the vehicle machine. The vehicle machine may decode the received encoded audio data and play the decoded audio data (e.g., the music).

In operation S102, based on receiving a sharing command on the vehicle machine, the first electronic apparatus and a second electronic apparatus may establish a predetermined wireless communication connection. The predetermined wireless communication connection may be and/or may include a short range wireless communication connection, such as Bluetooth™, wireless fidelity (WiFi), near-field communication (NFC), ZigBee, or the like.

According to the embodiment of the present disclosure, a projected content sharing function of the vehicle machine may be provided in the first electronic apparatus. When the first electronic apparatus enables the projected content sharing function of the vehicle machine, a sharing widget (e.g., a sharing button) may be created in the virtual screen, and the sharing widget may be projected and/or displayed on a predetermined content of the screen of the vehicle machine. In this manner, a share command may be generated by clicking the sharing widget. That is, when the sharing widget displayed on the screen of the vehicle machine is clicked, the predetermined content corresponding to the sharing widget may be selected as the content desired to be shared. Alternatively or additionally, the sharing command may also be generated by a voice input.

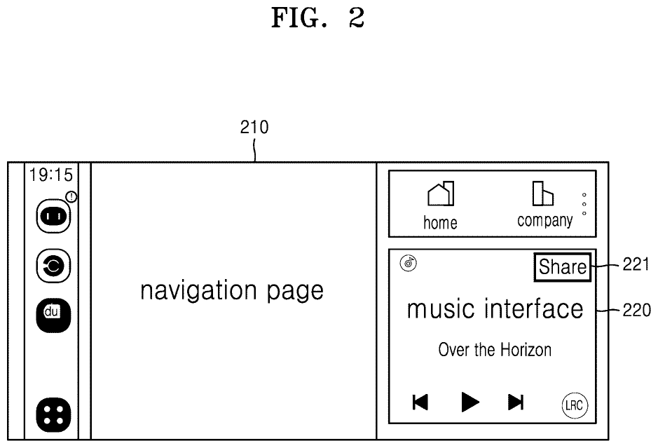

FIG. 2 is a diagram illustrating an example of displaying a sharing widget on a predetermined content on a screen of a vehicle machine. As shown in FIG. 2, the virtual screen may displayed on the screen of the vehicle machine, and the virtual screen may display a navigation page 210 and its buttons, as well as, a music interface 220 and its buttons. When the projected content sharing function of the vehicle machine is enabled, the sharing widget 221 for sharing the music desired to be shared may be displayed on the music interface 220. For example, the sharing widget 221 may be displayed after a music title displayed on the music interface 220. When the sharing widget 221 is clicked, the sharing command may be generated so that the corresponding music is selected as the predetermined content. Alternatively or additionally, when the user makes a voice input such as “I want to share the music”, the sharing command may also be generated so that the corresponding music may be selected as the predetermined content. Alternatively or additionally, based on receiving the sharing command on the vehicle machine, the first electronic apparatus may also generate sharing data corresponding to the sharing command (e.g., the sharing data of the predetermined content to be shared). As used herein, the shareable predetermined content projected and displayed on the screen of the vehicle machine may include at least one of the following content: a page, an image and/or a text currently being viewed, and an audio and/or video currently being played. The sharing data may include links of the page, the image and/or the text currently being viewed, and/or links of the audio and/or the video currently being played. Alternatively or additionally, if the page, the image and/or the text currently being viewed, and the audio and/or the video currently being played are stored in the first electronic apparatus, the sharing data may include the image and/or the text currently being viewed, and the audio and/or the video currently being played, rather than their links. However, the present disclosure is not limited thereto, and the predetermined content may be and/or may include any shareable content which may be projected and displayed, and the sharing data may be data related to the any shareable content which may be projected and displayed (e.g., a link to the content or the content itself).

According to an embodiment of the present disclosure, when the first electronic apparatus enables the projected content sharing function of the vehicle machine, a content selection widget and a sharing widget 221 (e.g., a sharing button) may be created in the virtual screen, and projected and displayed on the predetermined content of the screen of the vehicle machine. The content selection widget may be used to select the predetermined content on the screen of the vehicle machine. In this manner, after selecting one or more predetermined content desired to be shared through the content selection widget, the sharing command may be generated through the voice input and/or clicking of the sharing widget 221. For example, when a music list is displayed on the music interface 220, a checkbox (e.g., the content selection widget) may be displayed before each music title for selecting the music desired to be shared, and the sharing widget 221 may be displayed on the music interface 220. In an embodiment, when the sharing widget 221 is clicked after selecting a plurality of music by the checkbox, the plurality of selected music may serve as the predetermined content desired to be shared. Similarly, based on receiving the sharing command on the vehicle machine, the first electronic apparatus may also generate the sharing data corresponding to the sharing command (e.g., the sharing data of the predetermined content to be shared). The shareable predetermined content projected and displayed on the screen of the vehicle machine includes at least one of a page, an image, a text, an audio and/or a video displayed on the screen of the vehicle machine, for example, a main page and other thumbnail views displayed on the screen of the vehicle machine, the image displayed in a list and/or a thumbnail on the screen of the vehicle machine, the text, the audio and/or the video displayed in a list on the screen of the vehicle machine. Alternatively or additionally, the sharing data may include links of the page, the image, the text, the audio and/or the video, or the page, the image, the text, the audio and/or the video stored in the first electronic apparatus.

According to an embodiment of the present disclosure, if the projected content sharing function of the vehicle machine is not enabled, the sharing widget 221 may not be displayed on the music interface 220.

Alternatively, the first electronic apparatus may include a customized data interface for some third-party applications (which may also be referred to as apps). The first electronic apparatus may obtain data of the third party through the customized data interface, including the link of the audio, the link of the video, the link of the page, or the like. When the user clicks the sharing widget 221 displayed on the screen of the vehicle machine to generate the sharing command, the first electronic apparatus may use the corresponding data (e.g., the link of the audio) obtained through the customized data interface as the sharing data according to the received sharing command.

In operation S103, the first electronic apparatus may send the sharing data corresponding to the sharing command to the second electronic apparatus through the predetermined wireless communication connection established between the first electronic apparatus and the second electronic apparatus. Alternatively or additionally, when the first electronic apparatus completes sending the sharing data corresponding to the sharing command to the second electronic apparatus, the first electronic apparatus may disconnect the predetermined wireless communication connection with the second electronic apparatus.

According to the embodiment of the present disclosure, based on receiving the sharing command on the vehicle machine, an enabled state of a wireless communication function of the first electronic apparatus may be detected. If it is detected that the wireless communication function of the first electronic apparatus is not enabled, an enabling widget for enabling the wireless communication function of the first electronic apparatus may be created in the virtual screen, and projected and displayed on the screen of the vehicle machine. If it is detected that the wireless communication function of the first electronic apparatus has been enabled, the first electronic apparatus and the second electronic apparatus may establish the predetermined wireless communication connection.

As described above, when establishing the communication connection between the first electronic apparatus and the vehicle machine, the wired communication connection or the wireless communication connection may be used. If the wireless communication connection is used to establish the communication connection with the vehicle machine, it may indicate that the wireless communication function of the first electronic apparatus has been enabled. In such a case, detecting whether the wireless communication function of the first electronic apparatus is enabled may not be needed, and consequently, the enabling widget may not need to be created. However, if the wired communication connection is used to establish the communication connection with the vehicle machine, it may be needed to detect whether the wireless communication function of the first electronic apparatus is enabled, and if the wireless communication function of the first electronic apparatus is not enabled, it may be needed to create the enabling widget.

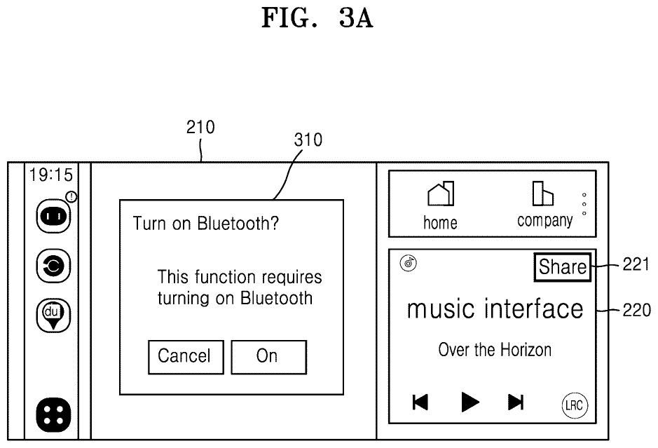

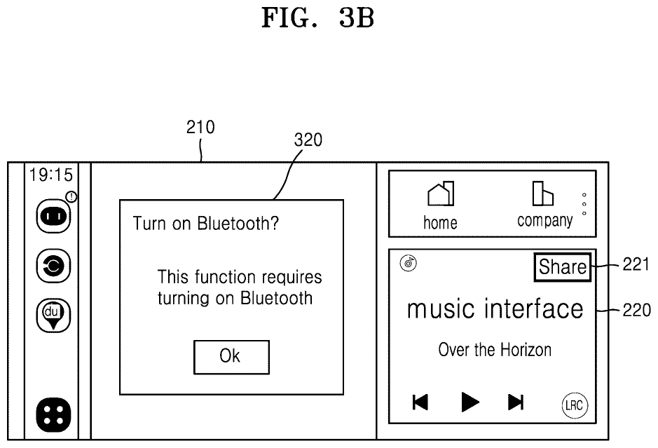

FIG. 3A is a diagram illustrating an example of displaying an enabling widget 310 on a screen of a vehicle machine. Referring to FIG. 3A, the enabling widget 310 may include a text prompt box and buttons. The text prompt box may display the text “This function requires turning on Bluetooth” or the like. Bluetooth is just one example of the wireless communication connection, and the present disclosure is not limited in this regard. For example, the text prompt box may prompt for turning on other wireless communication functions without departing from the scope of the present disclosure. The buttons may include “On” and “Cancel” buttons. When the On button is clicked, the first electronic apparatus may enable the wireless communication function, such as Bluetooth. Alternatively, when the Cancel button is clicked, the first electronic apparatus may disable the wireless communication function. That is, clicking of the Cancel button may indicate that the user does not expect or accept performing the content sharing. Although the enabling widget 310 is displayed in a particular location as shown in FIG. 3A, the particular location is only an example, and the present disclosure is not limited thereto. That is, the enabling widget 310 may be displayed anywhere on the screen of the vehicle machine, for example, on the predetermined content desired to be shared.

According to the embodiment of the present disclosure, if it is detected that the wireless communication function of the first electronic apparatus has been enabled, the first electronic apparatus may scan other electronic apparatus that may be connected. As described above, if the first electronic apparatus establishes the communication connection with the vehicle machine in a wireless communication connection manner, it may indicate that the wireless communication function of the first electronic apparatus has been enabled. Alternatively or additionally, in response to the enabling widget 310 being selected, the wireless communication function of the first electronic apparatus may be enabled. Therefore, in the above cases, it may be detected and/or determined that the wireless communication function of the first electronic apparatus has been enabled. When one or more other electronic apparatus that may be connected are scanned, the scanned other electronic apparatus may be projected and displayed on the screen of the vehicle machine through the virtual screen, and a selection for the other electronic apparatus may be received on the vehicle machine. Subsequently, based on selecting at least one from the other electronic apparatus as the second electronic apparatus, the first electronic apparatus may establish the predetermined wireless communication connection with the second electronic apparatus. For example, a name (e.g., an icon) of each of the other electronic apparatus may be displayed on the screen of the vehicle machine, and the selection widget for selecting each of the other electronic device may be displayed. For example, the selection widget may be displayed as a button or may be displayed as the icon of each of the other electronic device. When the other electronic apparatus desired to be connected is selected through the selection widget, the first electronic apparatus may establish the wireless communication connection with the selected other electronic device. Alternatively or additionally, a checkbox may also be displayed before the name of each of the other electronic apparatus for selecting the other electronic apparatus desired to be connected, and a single selection widget may be displayed on the screen of the vehicle machine. In such a case, when the selection widget is clicked after a plurality of other electronic apparatus are selected through the checkbox, the first electronic apparatus may establish the wireless communication connection with the plurality of selected other electronic devices. A way of selecting other electronic apparatus as the second electronic apparatus is exemplarily described above, however, the present disclosure is not limited thereto, and the second electronic apparatus may be selected from the other electronic apparatus projected and displayed on the screen of the vehicle machine in another manner without departing from the scope of the present disclosure.

Alternatively or additionally, based on receiving the sharing command on the vehicle machine, the prompt icon for prompting to enable the wireless communication function of the second electronic apparatus may be created in the virtual screen, and projected and displayed on the screen of the vehicle machine. FIG. 3B is a diagram illustrating an example of displaying a prompt icon 320 on a screen of a vehicle machine. Referring to FIG. 3B, the prompt icon 320 may include a text prompt box and a button. The text prompt box may display the text “This function requires turning on Bluetooth” or the like. As described above, Bluetooth is only one example of the wireless communication connection, and the present disclosure is not limited in this regard. For example, the text prompt box may prompt for turning on other wireless communication functions without departing from the scope of the present disclosure. The button may include an “OK” button. When the OK button is clicked, it may indicate that the second electronic apparatus has enabled the wireless communication function. Although the prompt icon 320 is displayed in a particular location as shown in FIG. 3B, the particular location is only an example, and the present disclosure is not limited thereto. That is, the prompt icon 320 may be displayed anywhere on the screen of the vehicle machine, for example, on the predetermined content desired to be shared.

Alternatively or additionally, when the second electronic apparatus receives the sharing data, it may parse the received sharing data, and display the parsed sharing data on its screen, for example, a link of a page, a link of an audio, a link of a video, a link of an image, a link of a text, an audio, a video, an image, a text, or the like. Subsequently, the user may operate the displayed shared data, for example, download or play the music by clicking on the link of the audio.

Based on the content sharing method for the first electronic apparatus, according to an embodiment of the present disclosure, when sharing content between the electronic apparatus of the driver and the passenger in the vehicle environment, it may not only reduce or potentially avoid a hidden danger of driving safety caused by the driver's distraction, but may also avoid a personal privacy leakage caused by an interconnection of the electronic apparatus (e.g., adding friends) or the passenger using the electronic apparatus of the driver.

Additionally, based on the content sharing method for the first electronic apparatus, according to the embodiment of the present disclosure, when sharing content between the electronic apparatus of the driver and the passenger in the vehicle environment, a problem that the content desired to be shared may not be accurately acquired since detailed information (e.g., version information) of the content desired to be shared may not be known, may be avoided.

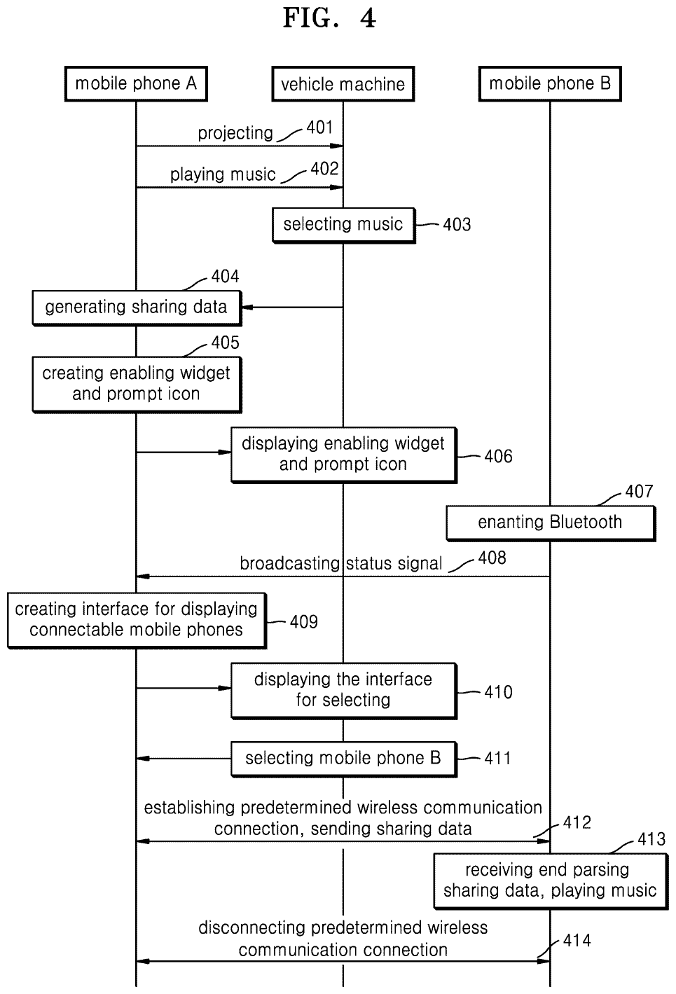

FIG. 4 is a diagram illustrating an interactive example of a content sharing method for a first electronic apparatus, according to an embodiment of the present disclosure.

Referring to FIG. 4, the interaction example of performing a content sharing between the first electronic apparatus and a second electronic apparatus through a vehicle machine is shown. In an embodiment, as an example, the first electronic apparatus may be referred to as a driver's mobile phone A, and the second electronic apparatus may be referred to as a passenger's mobile phone B.

In operation 401, the mobile phone A may be connected to the vehicle machine in a wired communication connection manner or a wireless communication connection manner, create a virtual screen, and project and display the virtual screen on a screen of the vehicle machine. At the same time, the mobile phone A may enable a projected content sharing function of the vehicle machine.

In operation 402, the mobile phone A may play music, display a page, or the like through the vehicle machine according to the driver's operation on the mobile phone A or the driver's or passenger's operation on the screen of the vehicle machine. In such a case, since the projected content sharing function of the vehicle machine has been enabled, the screen of the vehicle machine may display a sharing widget 221 for selecting the music, the page, or the like to share.

In operation 403, the passenger may select content (e.g., the music) desired to be shared by operating the sharing widget 221 (e.g., clicking the sharing widget 221), at the same time, a sharing command is generated.

In operation 404, the mobile phone A may generate sharing data about the selected music according to the sharing command received on the vehicle machine. The shared data about the selected music may include a link of the selected music or the selected music itself (e.g., a local audio file).

In operation 405, the mobile phone A may create an enabling widget 310 for enabling a wireless communication function of the mobile phone A and a prompt icon 320 for prompting to enable a wireless communication function of the mobile phone B in the virtual screen. For example, if the mobile phone A is connected to the vehicle machine in the wireless communication connection in operation 401, there may be no need to generate the enabling widget 310.

In operation 406, the screen of the vehicle machine may display the enabling widget 310 and the prompt icon 320.

In operation 407, the mobile phone B may enable the wireless communication function. For example, the mobile phone B may enable the wireless communication function during operations 401 to 406, and may enable the wireless communication function even before operation 401.

In operation 408, the mobile phone B may broadcast a status signal indicating that the mobile phone B may perform a wireless communication connection with other electronic apparatus. For example, after the mobile phone B enables the wireless communication function, the mobile phone B may broadcast the status signal periodically, and/or may broadcast the status signal according to an operation of the passenger.

In operation 409, based on scanning the connectable mobile phone B, the mobile phone A may create an interface for displaying the scanned connectable mobile phones (e.g., an interface for displaying an icon of the mobile phone B) in the virtual screen, and project and display it on the screen of the vehicle machine.

In operation 410, the screen of the vehicle machine may display the interface for displaying the scanned connectable mobile phones (e.g., the interface for displaying the icon of the mobile phone B) created and projected in operation 409, for users to select.

In operation 411, the passenger may confirm that the mobile phone B desires to connect with the mobile phone A by operating the selection widget for content sharing.

In operation 412, the mobile phone A may establish a predetermined wireless communication connection (e.g., a short range wireless communication connection) with the mobile phone B according to the operation of the passenger in operation 410 for the selection widget, and send the generated sharing data about the selected music to mobile phone B.

In operation 413, the mobile phone B may parse the received sharing data about the selected music, and display the parsed sharing data about the selected music on a screen of the mobile phone B. Afterwards, the passenger may operate the displayed shared data about the selected music, so as to obtain the selected music (e.g., play the music, download the music, or the like).

In operation 414, after the sharing data is sent to the mobile phone B, or after the mobile phone B receives the sharing data, the mobile phone A may disconnect the predetermined wireless communication connection with the mobile phone B. In an embodiment, operation 414 may be performed before operation 413.

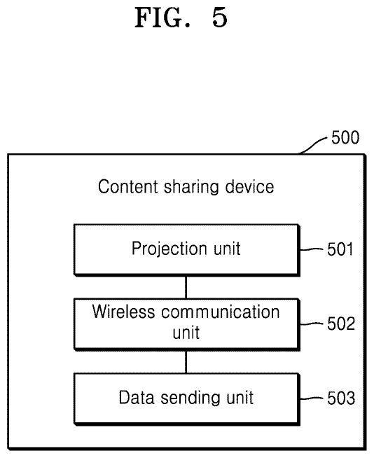

FIG. 5 is a block diagram illustrating a content sharing device for a first electronic apparatus, according to an embodiment of the present disclosure.

Referring to FIG. 5, a content sharing device 500 may include a projection unit 501, a wireless communication unit 502, and a data sending unit 503.

The projection unit 501 may project a virtual screen created in the first electronic apparatus to a screen of a vehicle machine for displaying. The virtual screen may be a screen created by the first electronic apparatus according to a screen size of the vehicle machine and suitable for being displayed on the screen of the vehicle machine. The wireless communication unit 502 may establish a predetermined wireless communication connection (e.g., a short range wireless communication connection) with a second electronic apparatus based on receiving a sharing command on the vehicle machine. The data sending unit 503 may send sharing data corresponding to the sharing command to the second electronic apparatus through the predetermined wireless communication connection established between the first electronic apparatus and the second electronic apparatus.

According to an embodiment of the present disclosure, the content sharing device 500 may further include a first creating unit. In response to the first electronic apparatus enabling a projected content sharing function of the vehicle machine, the first creating unit may create a sharing widget 221 in the virtual screen, and project and display it on a predetermined content on the screen of the vehicle machine. For example, the sharing command may be generated through a voice input and/or clicking the sharing widget 221. The predetermined content may include at least one of a page, an image and/or a text currently being viewed, an audio and/or a video currently being played.

Alternatively or additionally, the content sharing device 500 may further include a second creating unit. In response to the first electronic apparatus enabling the projected content sharing function of the vehicle machine, the second creating unit may create a content selection widget and the sharing widget 221 in the virtual screen, and project and display them on the screen of the vehicle machine. The content selection widget may be used to select the predetermined content on the screen of the vehicle machine. As such, after selecting one or more predetermined content desired to be shared through the content selection widget, the sharing command may be generated through the voice input and/or clicking the sharing widget 221. The shareable predetermined content projected and displayed on the screen of the vehicle machine may include at least one of a page, an image, a text, an audio and/or a video displayed on the screen of the vehicle machine, and the sharing data may include links of the page, the image, the text, the audio and/or the video, or the page, the image, the text, the audio and/or the video stored in the first electronic apparatus.

According to the embodiment of the present disclosure, the wireless communication unit 502 may detect an enabled state of a wireless communication function of the first electronic apparatus based on receiving the sharing command on the vehicle machine, create an enabling widget 310 for enabling the wireless communication function of the first electronic apparatus in the virtual screen, and projecting and displaying it on the screen of the vehicle machine, in response to detecting that the wireless communication function of the first electronic apparatus is not enabled, and establish the predetermined wireless communication connection with the second electronic apparatus, in response to detecting that the wireless communication function of the first electronic apparatus has been enabled. Furthermore, the wireless communication unit 502 may scan other electronic apparatus that may be connected in response to detecting that the wireless communication function of the first electronic apparatus has been enabled, project and display the scanned other electronic apparatus on the screen of the vehicle machine through the virtual screen, and receive a selection for the other electronic apparatus on the vehicle machine, establish the predetermined wireless communication connection with the second electronic apparatus, based on selecting at least one from the other electronic apparatus as the second electronic apparatus.

Alternatively, the wireless communication unit 502 may further create a prompt icon 320 for prompting to enable a wireless communication function of the second electronic apparatus, and project and display it on the screen of the vehicle machine, based on receiving the sharing command on the vehicle machine. Alternatively or additionally, the wireless communication unit 502 may disconnect the predetermined wireless communication connection with the second electronic apparatus, in response to the data sending unit 503 completing sending the sharing data corresponding to the sharing command to the second electronic apparatus

A content sharing method for a first electronic apparatus, according to an embodiment of the present disclosure may be written as computer instructions or programs and stored on a computer readable storage medium. The computer programs, when executed by a processor, may implement the content sharing method for the first electronic apparatus as described above. Examples of the computer readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, compact-disc (CD) read-only memories (CD-ROMs), CD recordables (CD-Rs), CD recordables (CD+Rs), CD re-writables (CD-RWs), CD re-writables (CD+RWs), digital versatile disc (DVD) read-only memories (DVD-ROMs), DVD recordables (DVD-Rs), DVD recordables DVD+Rs), DVD re-writables (DVD-RWs), DVD re-writables (DVD+RWs), DVD random-access memories (DVD-RAMs), blu-ray (BD) read-only memories (BD-ROMs), BD recordables (BD-Rs), BD recordables low-to-high (BD-R LTHs), BE recordable-erasables (BD-Res), blue-ray or optical disk storage, hard disk drive (HDD), solid state drive (SSD), a card type memory such as multimedia card, secure digital (SD) or extreme digital (XD), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers may execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

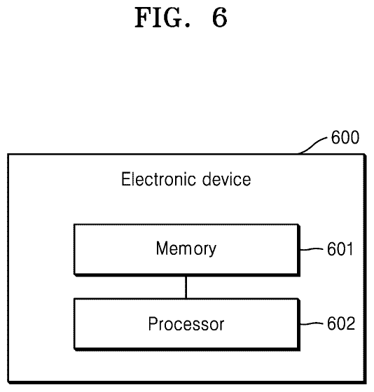

FIG. 6 is a block diagram illustrating an electronic apparatus, according to an embodiment of the present disclosure.

Referring to FIG. 6, an electronic apparatus 600 may include a memory 601 and a processor 602. The memory 601 may store computer programs. The computer programs, when executed by a processor, may implement a content sharing method for a first electronic apparatus, according to an embodiment of the present disclosure.

As an example, the electronic apparatus 600 may be a smart phone, a tablet device, a PDA, or other electronic devices capable of executing the above computer programs. In the electronic apparatus 600, the processor 602 may include a central processing unit (CPU), a graphics processing unit (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, or the like. The processor 602 may further run instructions or codes stored in the memory 601, where the memory 601 may also store data. The instructions and data may also be transmitted and received through a network via a network interface device, where the network interface device may use any known transmission protocol. The memory 601 may be integrated with the processor 602, for example, RAM or flash memory is arranged in an integrated circuit microprocessor or the like. In addition, the memory 601 may include a separate device, such as an external disk drive, storage array, or any other storage device that may be used by a database system. The memory 601 and the processor 602 may be operatively coupled, or may communicate with each other, for example, through an input/output (I/O) port, a network connection, or the like, so that the processor 602 may read files stored in the memory 601.

In addition, the electronic apparatus 600 may also include a video display (e.g., a liquid crystal display) and a user interaction interface (such as a keyboard, a mouse, a touch input device, or the like). All components of the electronic apparatus 600 may be connected to each other via a bus and/or a network.

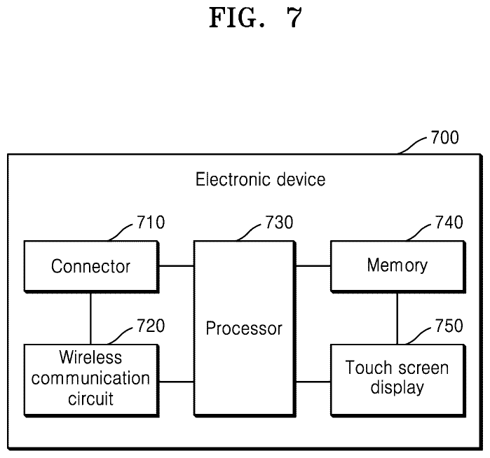

FIG. 7 is a block diagram illustrating an electronic apparatus, according to an embodiment of the present disclosure.

Referring to FIG. 7, an electronic apparatus 700 may include a connector 710, a wireless communication circuit 720, and at least one processor 730. Alternatively or additionally, the electronic apparatus 700 may further include a memory 740 and a touch screen display 750.

The connector 710 may be a connection port for connecting the electronic apparatus 700 to an external device. For example, the connector 710 may electrically connect the electronic apparatus 700 to a vehicle machine to establish a communication connection between the electronic apparatus 700 and the vehicle machine. The connector 710 may be, for example, a universal serial bus C (USB-C) type connector or the like.

The wireless communication circuit 720 may be used to allow the electronic apparatus 700 to perform a wireless communication with external servers, external devices, or the like (e.g., Bluetooth communication, WiFi communication, or the like). For example, the wireless communication circuit 720 may communicably connect the electronic apparatus 700 to the vehicle machine and/or a second electronic apparatus to establish a wireless communication connection between the electronic apparatus 700 and the vehicle machine and the second electronic apparatus.

The at least one processor 730 may be operably connected to the connector 710 and the wireless communication circuit 720, and execute instructions stored in the memory 740, so as to implement a content sharing method for a first electronic apparatus, according to an embodiment of the present disclosure. For example, when the electronic apparatus 700 establishes the communication connection with the vehicle machine through the connector 710 or the wireless communication circuit 720, the at least one processor 730 may project a virtual screen created in the electronic apparatus to a screen of a vehicle machine for displaying, control the wireless communication circuit 720 to establish a predetermined wireless communication connection with the second electronic apparatus, based on receiving a sharing command on the vehicle machine, and control the wireless communication circuit 720 to send sharing data corresponding to the sharing command to the second electronic apparatus, through the predetermined wireless communication connection established between the electronic apparatus and the second electronic apparatus.

The memory 740 may be electrically connected to the at least one processor 730 and may store the instructions executed by the at least one processor 730. For example, the memory 740 may store various operating systems (OS) for driving the electronic apparatus 700 and may store various software or applications for operating the electronic apparatus 700. In addition, the memory 740 may also store various data generated during the operation of the electronic apparatus 700. The memory 740 may include a volatile memory and/or a non-volatile memory.

The touch screen display 750 may display content of a main screen (e.g., a desktop) and interfaces for various applications, and may be used as a user interaction interface.

Based on a content sharing method and a content sharing device for a first electronic apparatus, a computer readable storage medium, and an electronic apparatus, according to embodiments of the present disclosure, when sharing content between electronic apparatus of a driver and a passenger in a vehicle environment, it may not only reduce and/or potentially avoid a hidden danger of driving safety caused by the driver's distraction, but may also avoid a personal privacy leakage caused by an interconnection of the electronic apparatus or the passenger using the electronic apparatus of the driver.

Additionally, based on the content sharing method and the content sharing device for the first electronic apparatus, the computer readable storage medium, and the electronic apparatus, according to the embodiments of the present disclosure, when sharing content between electronic apparatus of a driver and a passenger in a vehicle environment, a problem that the content desired to be shared cannot be accurately acquired since detailed information of the content desired to be shared cannot be known, may be avoided.

Other embodiments of the present disclosure may readily occur to those skilled in the art upon consideration of the specification and practice of the invention disclosed herein. This disclosure is intended to cover any variations, uses, or adaptations of this disclosure that follow the general principles of this disclosure and include common knowledge or commonly used technical means in the technical field not disclosed by this disclosure. The specification and embodiments are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

What is claimed is:

1. A content sharing method for a first electronic apparatus, the content sharing comprising:
creating a virtual screen for displaying to a vehicle machine;
projecting the virtual screen to a screen of the vehicle machine;
based on receiving a sharing command from the vehicle machine, establishing a predetermined wireless communication connection with a second electronic apparatus; and
sending, to the second electronic apparatus through the predetermined wireless communication connection, sharing data corresponding to the sharing command.

2. The content sharing method of claim 1, wherein the creating the virtual screen comprises:
creating the virtual screen based on a screen size of the vehicle machine.

3. The content sharing method of claim 1, further comprising:
based on the first electronic apparatus enabling a projected content sharing function of the vehicle machine, creating a sharing widget in the virtual screen, and projecting and displaying the sharing widget on a predetermined content on the screen of the vehicle machine; and
generating the sharing command based on at least one of a voice input or clicking the sharing widget.

4. The content sharing method of claim 3, wherein the predetermined content comprises at least one of a page, an image or a text currently being viewed, or an audio or a video currently being played.

5. The content sharing method of claim 1, further comprising:
based on the first electronic apparatus enabling a projected content sharing function of the vehicle machine, creating a content selection widget and a sharing widget in the virtual screen, and projecting and displaying the content selection widget and the sharing widget on the screen of the vehicle machine, the content selection widget being configured to select a predetermined content on the screen of the vehicle machine; and
generating the sharing command based on at least one of a voice input or clicking the sharing widget.

6. The content sharing method of claim 1, wherein the establishing of the predetermined wireless communication connection comprises:
detecting an enabled state of a first wireless communication function of the first electronic apparatus, based on receiving the sharing command on the vehicle machine;
based on detecting that the first wireless communication function is not enabled, creating an enabling widget for enabling the first wireless communication function in the virtual screen, and projecting and displaying the enabling widget on the screen of the vehicle machine; and
based on detecting that the first wireless communication function is enabled, establishing the predetermined wireless communication connection with the second electronic apparatus by the first electronic apparatus.

7. The content sharing method of claim 6, wherein the establishing of the predetermined wireless communication connection further comprises:
based on detecting that the first wireless communication function has been enabled, scanning another electronic apparatus communicatively coupled with the first electronic apparatus;
projecting and displaying the scanned other electronic apparatus on the screen of the vehicle machine through the virtual screen, and receiving a selection of the other electronic apparatus on the vehicle machine; and
based on selecting at least one from the other electronic apparatus as the second electronic apparatus, establishing the predetermined wireless communication connection with the second electronic apparatus by the first electronic apparatus.

8. The content sharing method of claim 6, wherein the establishing of the predetermined wireless communication connection with the second electronic apparatus further comprises:
based on receiving the sharing command on the vehicle machine, creating a prompt icon for prompting to enable a second wireless communication function of the second electronic apparatus, and projecting and displaying the prompt icon on the screen of the vehicle machine.

9. The content sharing method of claim 1, wherein the predetermined wireless communication connection comprises a short range wireless communication connection.

10. The content sharing method of claim 1, further comprising:
based on the first electronic apparatus completing sending the sharing data corresponding to the sharing command to the second electronic apparatus, disconnecting the predetermined wireless communication connection with the second electronic apparatus.

11. A first electronic apparatus comprising:
at least one processor;
memory storing instructions,
a content sharing device wherein the instructions are configured to, when individually or collectively executed by the at least one processor, cause the content sharing device to:
create a virtual screen for displaying to a vehicle machine;
project the virtual screen to a screen of the vehicle machine;
based on receiving a sharing command from the vehicle machine, establish a predetermined wireless communication connection with a second electronic apparatus; and
send, to the second electronic apparatus through the predetermined wireless communication connection, sharing data corresponding to the sharing command.

12. The content sharing device of claim 11, wherein the instructions are configured to, when individually or collectively executed by the at least one processor, further cause the content sharing device to:
create the virtual screen based on a screen size of the vehicle machine.

13. The content sharing device of claim 11, wherein the instructions are configured to, when individually or collectively executed by the at least one processor, further cause the content sharing device to:
based on the first electronic apparatus enabling a projected content sharing function of the vehicle machine, create a sharing widget in the virtual screen, and project and display the sharing widget on a predetermined content on the screen of the vehicle machine; and
generate the sharing command based on at least one of a voice input or clicking the sharing widget.

14. The content sharing device of claim 13, wherein the predetermined content comprises at least one of a page, an image or a text currently being viewed, or an audio or a video currently being played.

15. The content sharing device of claim 11, wherein the instructions are configured to, when individually or collectively executed by the at least one processor, further cause the content sharing device to:
based on the first electronic apparatus enabling a projected content sharing function of the vehicle machine, create a content selection widget and a sharing widget in the virtual screen, and project and display the content selection widget and the sharing widget on the screen of the vehicle machine, the content selection widget being configured to select a predetermined content on the screen of the vehicle machine; and
generate the sharing command based on at least one of a voice input or clicking the sharing widget.
